(19) United States
(12) Patent Application Publication
(10) Pub. No.: US 2014/0114619 A1
(43) Pub. Date: Apr. 24, 2014

(54) Burner Outlet Designs for Locomotive Burner Integration

(71) Applicant: TENNECO AUTOMOTIVE OPERATING COMPANY INC., Lake Forest, IL (US)

(72) Inventors: Manoj K. Sampath, Ann Arbor, MI (US); Guanyu Zheng, Novi, MI (US); Yanping Zhang, Livonia, MI (US); Adam J. Kotrba, Laingsburg, MI (US); Michael Golin, Dexter, MI (US); Figen Lacin Buyukbozkirli, Dexter, MI (US)

(73) Assignee: TENNECO AUTOMOTIVE OPERATING COMPANY INC., Lake Forest, IL (US)

(21) Appl. No.: 13/658,304

(22) Filed: Oct. 23, 2012

(51) Int. Cl. G06F 17/50

(52) U.S. Cl. 703/1

(57) ABSTRACT

A method of determining an optimized position for a burner in an exhaust aftertreatment system includes estimating temperature distributions across faces of exhaust treatment devices positioned within parallel paths based on an initial burner position upstream of the parallel paths. A temperature distribution across the faces of the exhaust treatment device is again estimated based on a changed burner position. A difference between the estimates is determined. The changing, estimating and determining steps are repeated to correlate the burner position with a temperature variance across the faces. An optimized burner position is determined based on minimizing the temperature variance across the faces of the exhaust treatment devices.

### FIELD

The present disclosure generally relates to a system for treating exhaust gases. More particularly, methodologies for optimizing a burner arrangement to increase an exhaust gas temperature as well as optimizing a reagent injector location are discussed.

### BACKGROUND

To reduce the quantity of NO_{X} and particulate matter emitted to the atmosphere during internal combustion engine operation, a number of exhaust aftertreatment devices have been developed. A need for exhaust aftertreatment systems particularly arises when diesel combustion processes are implemented. Typical aftertreatment systems for diesel engine exhaust may include one or more of a diesel particulate filter (DPF), a selective catalytic reduction (SCR) system, a hydrocarbon (HC) injector, and a diesel oxidation catalyst (DOC).

During engine operation, the DPF traps soot emitted by the engine and reduces the emission of particulate matter (PM). Over time, the DPF becomes loaded and begins to clog. Periodically, regeneration or oxidation of the trapped soot in the DPF is required for proper operation. To regenerate the DPF, relatively high exhaust temperatures in combination with an ample amount of oxygen in the exhaust stream are needed to oxidize the soot trapped in the filter.

The DOC is typically used to generate heat useful for regenerating the soot loaded DPF. When hydrocarbons (HC) are sprayed over the DOC at or above a specific light-off temperature, the HC will oxidize. This reaction is highly exothermic and the exhaust gases are heated during light-off. The heated exhaust gases are used to regenerate the DPF.

Under many engine operating conditions, however, the exhaust gas is not hot enough to achieve a DOC light-off temperature of approximately 300° C. As such, DPF regeneration does not passively occur. Furthermore, NOₓ absorbers and selective catalytic reduction systems typically require a minimum exhaust temperature to properly operate.

A burner may be provided to heat the exhaust stream upstream of the various aftertreatment devices. Known burners have successfully increased the exhaust temperature of relatively small displacement internal combustion engines for automotive use. However, other applications including diesel locomotives, stationary power plants, marine vessels and others may be equipped with relatively large diesel compression engines. The exhaust mass flow rate from the larger engines may be more than ten times the maximum flow rate typically provided to the burner. While it may be possible to increase the size of the burner to account for the increased exhaust mass flow rate, the cost, weight and packaging concerns associated with this solution may be unacceptable. Therefore, a need may exist in the art for a method to optimize an arrangement to increase the temperature of the exhaust output from a large diesel engine while minimally affecting the cost, weight, size and performance of the exhaust system.

Additional challenges exist relating to dispersion of injected reagent in relatively large exhaust treatment systems. In particular, some systems include multiple parallel flow paths containing exhaust to be treated. Injected reagent may flow into the closest inlet of least restriction. Some of the parallel paths may receive a greater quantity of reagent than required while other paths may receive less than intended. As such, it may be desirable to provide a methodology to optimize injector location in high volume exhaust systems.

To meet EPA Tier IV large diesel engine emission targets, intensive development efforts have been taken to achieve NOx reduction and Particulate Matter (PM) reduction targets. With respect to NOx reduction, liquid urea is typically used as the reagent to react with NOx via SCR catalyst. Regarding PM reduction, additional heat is required to raise exhaust temperature to reach a Diesel Particulate Filter (DPF) active/passive regeneration performance window. Typically the heat may be generated by external diesel burners which allow diesel liquid droplets to react directly with oxygen in the exhaust gas. Alternatively the heat can be generated by catalytic burners which enable diesel vapor to react with oxygen via a Diesel Oxidation Catalyst (DOC) mostly through surface reactions. The latest technology trend is to combine both mechanisms together so that (1) small-scale burners will enhance exhaust temperature to DOC activation temperature; (2) DOC with HC dosing will raise exhaust temperature to 650° C. to achieve active soot reduction.

From the scope of system level design, given the added reagents (HC and urea) and heat to exhaust gases, the need arises to achieve even distributions of exhaust gas velocity, good mixing of burner heat with exhaust gas and good mixing of reagents released from HC or urea injectors with exhaust gas, necessitating optimizations of multiphase heat and mass transport phenomena. To meet these multifaceted heat and mass transport targets, geometrical optimizations of subsystems are deemed important as well as the requirements of subcomponents such as burners and injectors. In this disclosure, a turbo-out manifold box is selected as the subsystem under study for design optimizations. Located between turbo-out ports and an exhaust aftertreatment system, the manifold is subject to burner heat injections and diesel liquid injections at multiple locations. The manifold therefore serves the mechanism to distribute exhaust gas, burner heat and diesel vapor. Downstream, the exhaust aftertreatment system incorporates multiple identical flow paths, each encompassing a DOC, a DPF, urea injectors, a Selective Catalytic Reduction Device (SCR), and an Ammonia Slip Catalyst (ASC) with complete PM and NOx reduction functionalities. Downstream of the exhaust aftertreatment system, a common stack outlet is created to be open to the environment. This disclosure discusses general design considerations, performance metrics and methodology for the development of turbo-out manifold with system targets in scope. Computational Fluid Dynamic modeling has been used as the main tool in performing design iterations.

In large-scale diesel engines such as locomotive, marine, stationary engines, the aftertreatment system development generally dictates modularity, simplicity and manufacturability for subsystems and components because the scalability and versatility have the benefits of being cost-effective and maintenance-friendly for many diverse systems. The system layouts may vary, but they must meet the comprehensive performance targets of back pressure, reductions of NOX, PM, CO and HC, system durability, cost, and maintenance.

### SUMMARY

This section provides a general summary of the disclosure, and is not a comprehensive disclosure of its full scope or all of its features.

A method of determining an optimized position for a burner in an exhaust aftertreatment system includes estimating temperature distributions across faces of exhaust treatment devices positioned within parallel paths based on an initial burner position upstream of the parallel paths. A temperature distribution across the faces of the exhaust treatment device is again estimated based on a changed burner position. A difference between the estimates is determined. The changing, estimating and determining steps are repeated to correlate the burner position with a temperature variance across the faces. An optimized burner position is determined based on minimizing the temperature variance across the faces of the exhaust treatment devices.

A method of determining an optimized position for a reagent injector in an exhaust aftertreatment system having multiple parallel exhaust gas flow paths includes estimating injected reagent distributions across faces of exhaust treatment devices positioned within the parallel paths based on an initial reagent injector position upstream of the parallel paths. The reagent injector position is changed. Another estimate of injected reagent distribution across the faces of the exhaust treatment devices is made based on the changed reagent injector position. A difference between the estimates is determined. An optimized reagent injector position is determined based on minimizing the reagent distribution variance across the faces of the exhaust treatment devices.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depicting an exemplary exhaust aftertreatment system constructed in accordance with the teachings of the present disclosure;

FIG. 2 is a schematic depicting an alternate exhaust gas treatment system;

FIG. 3 is a schematic of a large engine aftertreatment system;

FIG. 4 is a flow chart relating to a process for developing an exhaust aftertreatment system;

FIG. 5 is a fragmentary perspective view of a computational fluid dynamics model;

FIG. 6 is a front view of the computational fluid dynamics model;

FIG. 7 is a top view of the computational fluid dynamics model;

FIG. 8 is a perspective view of the computational fluid dynamics model depicting different burner locations;

FIG. 9 provides two different views of the computational fluid dynamics model burner locations;

FIG. 10 is a graph depicting mass flow split across the downstream legs for each of the modeled burner configurations;

FIG. 11 is a graph depicting system pressure loss for each of the configurations modeled;

FIGS. 12-19 depict exhaust gas temperature distribution at the inlets of diesel oxidation catalysts for each of the different configurations;

FIG. 20 is a graph depicting average leg temperature for each of the configurations modeled;

FIG. 21 is a graph depicting velocity and temperature uniformity for each configuration;

FIG. 22 is a graph depicting diesel oxidation catalyst inlet peak temperature for each design option;

FIG. 23 is a flow chart describing a burner position optimization process;

FIG. 24 is a fragmentary view of the modeled exhaust system depicting the various injector locations modeled;

FIGS. 25-28 depict the mass fraction of injected vapor at the inlet faces of the diesel oxidation catalysts for the various modeled configurations; and

FIG. 29 is a graph depicting the uniformity index of the injected fluid for the various modeled designs.

Corresponding reference numerals indicate corresponding parts throughout the several views of the drawings.

### DETAILED DESCRIPTION

Example embodiments will now be described more fully with reference to the accompanying drawings.

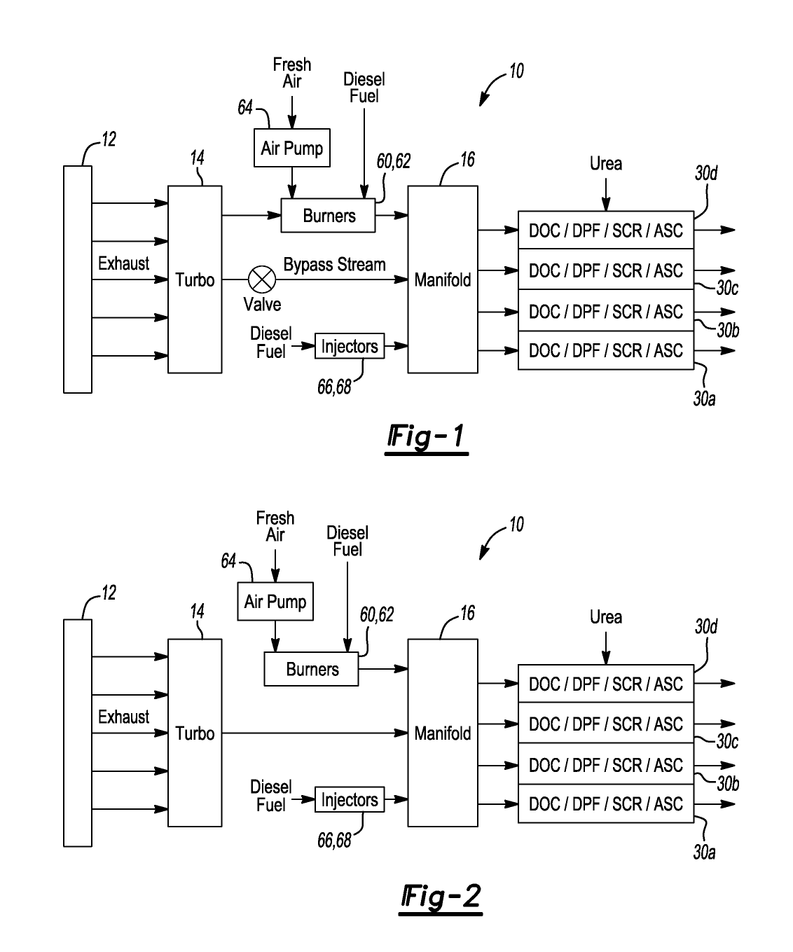

FIG. 1 depicts a diesel exhaust gas aftertreatment system 10 associated with an exemplary large displacement engine 12 such as found on a locomotive. A turbocharger 14 is driven with exhaust provided from engine 12. A turbo exhaust manifold 16 is positioned in an exhaust stream of engine 12 downstream from turbocharger 14. More particularly, turbo exhaust manifold 16 includes an inlet 18 in receipt of exhaust gases provided from engine 12 and four outlets identified with reference numerals 20, 22, 24 and 26. Four aftertreatment assemblies 30a, 30b, 30c, 30d are positioned in parallel fluid communication downstream from each of outlets 22 through 26. Each parallel path may be identified as a “leg.” Due to the substantial similarity of each aftertreatment assembly 30, only one will be described in detail.

Each aftertreatment assembly 30 includes a coupler 32 and a tri-pipe 33. Tri-pipe 33 includes a singular inlet 34 and three outlets identified as 35a, 35b and 35c. Downstream from each of outlets 35a, 35b, 36c is an aftertreatment subassembly identified with one of reference numerals 36a, 36b or 36c. The aftertreatment subassemblies are substantially identical to one another. Accordingly, only aftertreatment subassembly 36a will be described in detail.

Aftertreatment subassembly 36a includes a diesel oxidation catalyst 37a, a diesel particulate filter 38a, a urea injector 40a, a urea mixer 42a, a selective catalytic reduction element 44a and an ASC 46a. An outlet 54 allows the treated exhaust to escape to atmosphere. To properly operate diesel oxidation catalysts 37a, 37b and 37c, at least a first burner 60 is coupled in communication with turbo exhaust manifold 16 to heat the exhaust gas passing through turbo exhaust manifold 16 and raise the temperature of each diesel oxidation catalyst 37a, 37b, 37c to approximately 285° C. to allow active HC dosing for active regeneration of each DPF 38a, 38b, 38c. Additional burners are contemplated and two or more burners are likely to be required. An air pump 64 may provide fresh air to the burners. A supply of fuel is also provided to the burners. Through computer modeling, it has been determined that two burners 60 and 62 may be required to properly increase the temperature of each of the twelve diesel oxidation catalysts implemented within the particular exhaust aftertreatment system 10 modeled. By properly positioning only two burners, as described hereinafter, cost and weight of the aftertreatment system may be minimized. The optimized position of burners 60 and 62 provides even distribution of burner heat to each aftertreatment assembly 30 as well as each aftertreatment assembly 36a, 36b and 36c. Computational Fluid Dynamic modeling estimates a temperature uniformity of more than 93% across all aftertreatment subsystems 36a, 36b and 36c.

Reagent injectors 66, 68 are positioned to inject a reagent, such as a hydrocarbon, into exhaust manifold 16. Computational Fluid Dynamic modeling analysis indicates that only two injectors need be provided as long as the injector positions are optimized. It should be appreciated that more or fewer burners or injectors may be required for an exhaust treatment system configured differently than modeled system 10.

As mentioned, FIG. 1 provides a schematic overview of an exhaust aftertreatment system 10. After the in-cylinder combustion is complete in large diesel engines, exhaust gas flows through the turbocharger, turbo manifold and necessary catalyzed substrates including DOC, DPF, SCR and ASC. In the embodiment depicted in FIG. 1, the mainstream of the exhaust gas is split into two streams including a burner stream and a bypass exhaust stream before reaching the manifold. Proper control mechanisms are adopted to accurately adjust the mix between the burner stream and the bypass stream. Both streams then merge in the manifold where diesel fuel injected into the manifold and heat from the burners are mixed with exhaust gas. Downstream of the manifold, multiple banks of catalyzed substrates are provided to enable reductions of pollutants including HC, CO, PM and NOx.

FIG. 2 provides a schematic overview of an exhaust aftertreatment system 10a. Exhaust aftertreatment system 10a is substantially the same as exhaust aftertreatment system 10 with the exception that the main exhaust stream output from turbocharger 14 is not split into two streams but provided entirely to exhaust manifold 16. Burners 60, 62 are supplied with fresh air from air pump 64. It should be appreciated that the concepts disclosed in this disclosure apply to either type of aftertreatment system.

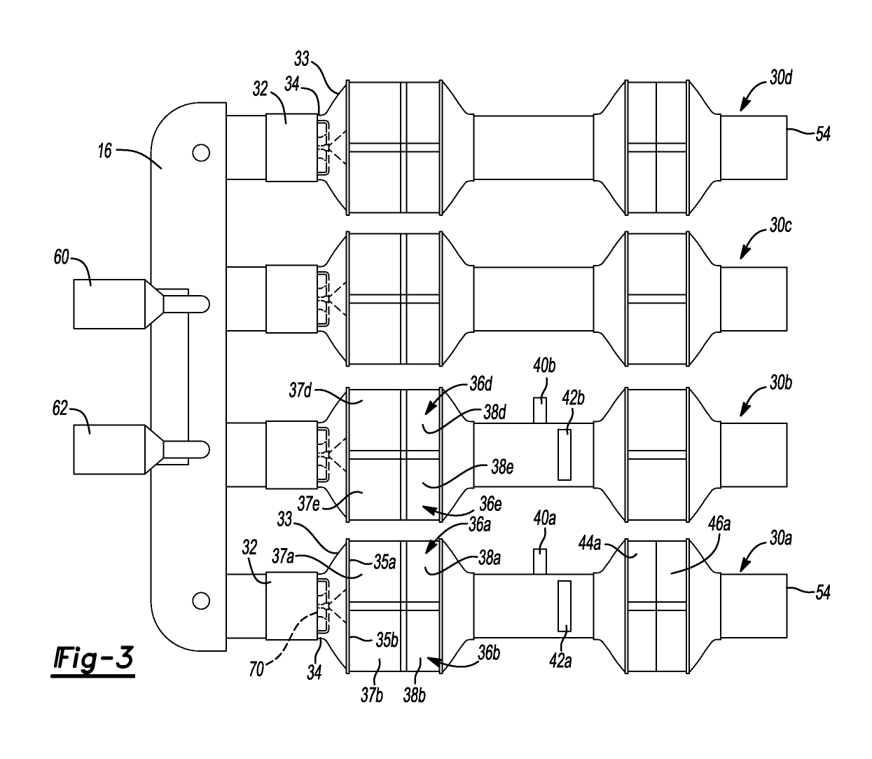

FIG. 3 depicts a representative geometry of the manifold and downstream subsystems. Exhaust gas from the turbo outlet enters the turbo manifold. Downstream are velocity mixer, DOC, DPF, SCR and ASI. As shown, the modularity philosophy has resulted in aftertreatment systems encompassing multiple identical flow paths, each possessing functionality of HC, CO, PM and NOx reductions. The challenges, however, are that the flow, heat and reagents must be well mixed and distributed given a specific packaging space. Multiple contributing factors to performances are turbo-box design, burner mounting locations, and diesel injector locations.

Given the multitude of its functionalities, the design objectives of turbo exhaust manifold are (1) to distribute the exhaust mass flow evenly to multiple legs, following similar design principles to that of gasoline engine exhaust manifold; (2) to receive and mix heat from multiple burners mounted on the manifold to facilitate active regeneration downstream by raising low exhaust temperatures to DOC light-off temperature such as 285° C.; (3) to receive and mix diesel fuel spray from fuel injectors mounted on the manifold by raising exhaust temperature (equal or higher than 285° C.) to DPF active regeneration temperature of 650° C. To achieve these objectives, it is necessary to formulate multifaceted mixing performance targets in species, temperature and velocity with corresponding solution schemes.

TABLE 1
Performance metrics to evaluate turbo manifold performance.

| | Key Performance Areas | Performance Metrics |
|---|---|---|
| 1 | Mass flow split to each leg | Standard deviation of mass flow rates to |
| | | legs |
| 2 | Localized space velocity | Velocity uniformity at DOC front face |
| | of DOC substrates | |
| 3 | Mixing of external burner | Temperature uniformity at DOC front |
| | heat with exhaust gas | face |
| 4 | Mixing of hydrocarbon | Hydrocarbon vapor uniformity at DOC |
| | with exhaust gas | front face |

Four performance metrics are derived in Table 1 to evaluate the turbo-box performance. The performance metrics 1 and 2 ensure that each leg will receive equal share of exhaust mass flow with well-distributed exhaust velocity at the inlet of the DOC. If absent of added heat and reagents, as seen in gasoline engine applications, both metrics are sufficient for exhaust manifold design. The performance metric 3 is used to quantify the effect of mixing between burner heat and exhaust flow. The performance metric 4 is used to evaluate the mixing between liquid diesel spray and exhaust gas. Both 3 and 4 are means to satisfy the functionality of PM active regeneration.

With respect to PM reduction for diesel engines, proper thermal management of burner heat includes consideration of multiple factors: (1) burner size and power output; (2) the number of burners; (3) the exit temperature of burner; (4) the locations of burners. As shown in FIG. 1, the burners may be provided with a separate stream of exhaust gas from the mainstream along with fresh air input via air compressor and fuel input from an atomizer. The configuration of FIG. 2 shows burners 60, 62 in receipt of only fresh air.

Burners 60, 62 are able to supply a range of consistent hot gas flow rate at fixed temperature of 650° C., the normal burner operating temperature. The burner stream may be in parallel to the bypass stream as both streams are diverted from the main stream at the turbo-out. The purpose of burner 60, 62 is to raise exhaust temperature to a DOC activation temperature of 285° C., not to raise exhaust temperature to 650° C. The latter scenario may require an in-line burner configuration with higher required external heat flow rate and hence larger burner heat capacities. This configuration may increase system backpressure from the burner in a passive mode. Therefore, if the engine is at low idle condition below 285° C., burner heat is provided to reach DOC activation temperature 285° C. The exhaust gas needs to meet performance metric 3 to achieve temperature distribution criteria. If the engine temperature is beyond DOC activation temperature, indicating no additional heat is required, performance metric 3 is not needed.

Burner activation may not be required if active regenerations are not needed for low idle conditions, as seen in some on-highway heavy-duty truck applications. However, low idle regeneration may become crucial for off-highway heavy duty, stop-and-go refuse trucks or switch locomotive applications where PM have to be regenerated periodically during idle conditions. In these scenarios, the burner may be either standalone or combined with a HC dosing mechanism.

Once the exhaust gas temperature satisfies the DOC activation temperature, a hydrocarbon may be dosed on DOC 37a thereby generating additional heat causing the exhaust temperature to reach 650° C.

Note that the DPF regeneration temperature is assumed to be 650° C. In contrast, catalyzed DPF may enable passive regeneration at lower temperature via NO2 soot oxidization. In the latter scenario, the need of active regeneration via HC dosing or burners may be less demanded, but active regeneration may still provide failsafe benefits as a means to mitigate long term deterioration of catalyst and accumulated urea deposit. Occasional active regenerations may alleviate major risks to system robust performance.

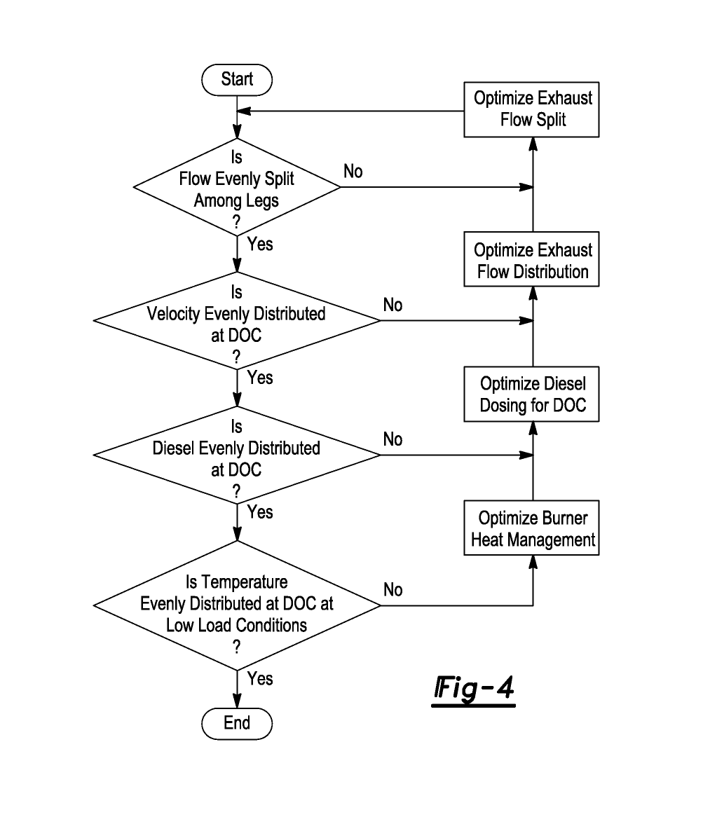

The process for turbo manifold development is shown in FIG. 4. Multiple key questions need to be answered sequentially based on the priorities. Logically, the performance of flow split and velocity distribution should be satisfied first, followed by performance of hydrocarbon and heat distribution.

Because of the large dimension of the whole system, validation of the manifold performance poses a considerable challenge. Small scale tests are possible but may not represent the workings of the full geometry. One reason is that mixing, in essence, cannot be downscaled along with other flow characteristics. In contrast, CFD methodology could be a viable approach for this purpose since it has been established and benchmarked to some degrees in multiple test scenarios on spray modeling validations. Application experience indicates that CFD velocity simulations have been correlated relatively well with test results. With respect to spray modeling, it has been observed that system design directions provided by spray modeling correlate with the directions from test observations. Though still subject to limitations, the CFD modeling approach provides fast-turnaround design cycles and cost-effective means to address the complicated mixing and transport phenomena.

With the CFD spray modeling approaches, the system design has been improved stepwise with the final system being able to achieve pre-set performance targets of mass flow, temperature and fuel vapor distribution.

The CFD computational domain is meshed using Ansys ICEMCFD and consists of hybrid elements with 3 million cells. The substrates are modeled using hexahedral elements, manifold and other subsystems are captured using tetrahedral and 2 layer prism elements. Ansys Fluent is used as solver. For burner inlet study, continuity, momentum and energy term equations are solved sequentially. For injector location studies, spray model and species transport are added. In model setup, a steady state pressure based solver (Segregated) and 2 equation realizable k-e turbulence models with standard wall functions is used. As simplifications, radiation and heat transfer through the wall thickness are not modeled. The appropriate equations and model setup are selected for the corresponding analysis. Spray modeling is conducted using ‘Discrete Phase Model’ with quasitransient approach where the fluid flow is steady and particle trajectory unsteady.

The droplets are calculated to account for interaction with the flow field at each iteration step in order to enable two-way couplings. Spherical drag law is assumed for droplets drag parameters and droplet breakup as wave model with default constants is applied. The HC droplets are defined via solid cone spray pattern and diameter distribution is applied via ‘Rosin-Rammler’ fit derived from spray characterization of the injector. DPM wall boundary conditions are treated as wall-jet for the geometry upstream of substrates; for the substrates and the downstream components, the droplet transport is treated as “trap”, meaning the droplet will have a localized effect after hitting walls.

Returning to FIG. 3, internal deflectors 70 are positioned within the exhaust path in order to evenly distribute the velocity to the DOC substrate inlet faces. Deflectors 70 may be otherwise identified as flow modifiers or mixers. In the example analyzed, the inlet cross-section of the turbo outlet to the manifold is 7.5″ width and 33.8″ depth. The ID of the inlet 34 and DOCs 37a, 37b, 37c were 12.5″ diameter and 12″ diameter respectively. The ID of the burner outlet to the manifold box is 3″. Since the scope of this project is to optimize the flow distribution in the DOC/DPF inlet faces, the downstream components of SCR/ASC are not modeled. Due to symmetry nature of domain, half geometry is sufficient to represent the full system performance by assuming that no unsymmetrical behavior occurs at the turbo outlet. In other words, if unsymmetrical behavior such as swirl occurs, full system geometry is required for modeling.

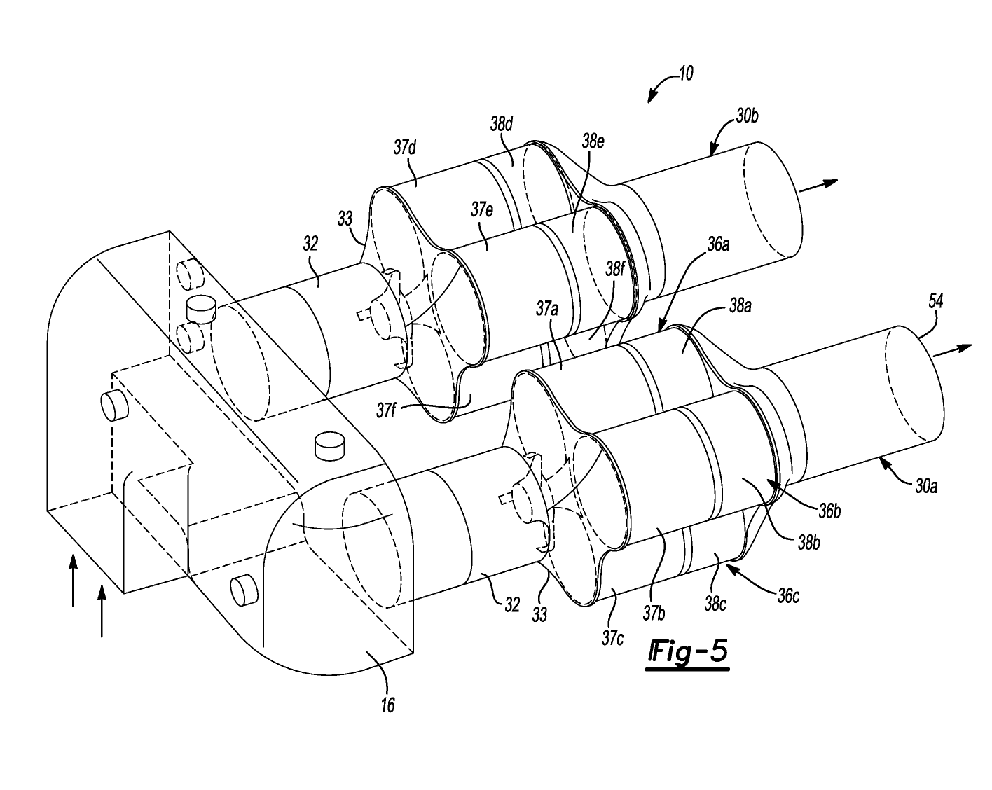

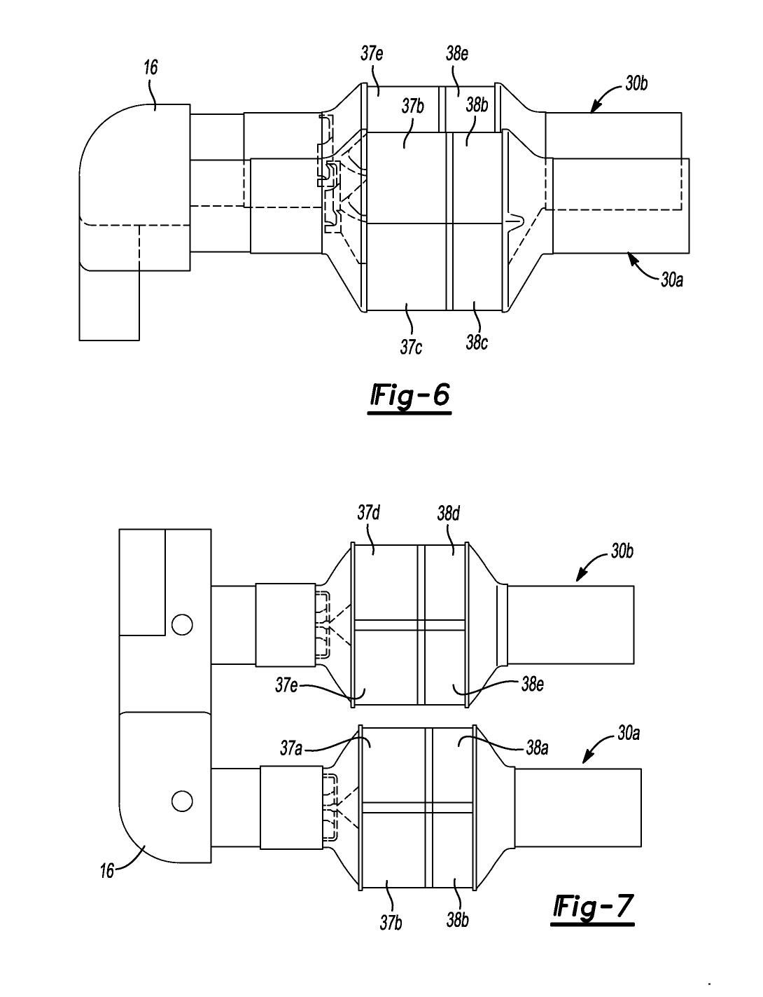

FIG. 5 shows the CFD domain with the manifold box and substrates. FIGS. 6 and 7 show additional views of the system. The flow at the turbo outlet enters the CFD domain in vertical direction, as shown by the inlet at the bottom of the manifold box. Then the flow splits into multiple legs. The resulting flow in each leg is then distributed to the three DOC/DPF substrates, passing a diverter in the inlet cone upstream of DOC. The flow downstream the substrates is merged at the outlet cone which is connected to a straight pipe. In the full system, downstream of these DOC/DPF substrates will be the urea dosing system including mixers and SCR/ASC assemblies.

This disclosure relates to two sensitivity studies, burner inlet optimization and injector location optimization. Burner inlet studies and injector studies are conducted separately by using the same CFD model geometry. In the burner sensitivity study, three parameters are selected for design optimization, the pressure loss, mass flow non-uniform flow out from turbo split and temperature distribution respectively. The flow split across each leg shows how well the current manifold design distributes the mass flow across the two legs. Different burner flow locations are formulated with the goal to reach optimized burner locations according to performance criteria of temperature distributions across DOC. Once the design direction has been identified, further fine-tuning is conducted for the final burner locations. In the HC injector sensitivity study, hydrocarbon droplets are injected at different locations to determine an optimized position of the injectors according to the performance criteria of even species distributions across the DOC faces. It should be appreciated that the optimization process described may also apply to other emissions control devices such as exhaust flow modifiers or mixers without departing from the scope of the disclosure.

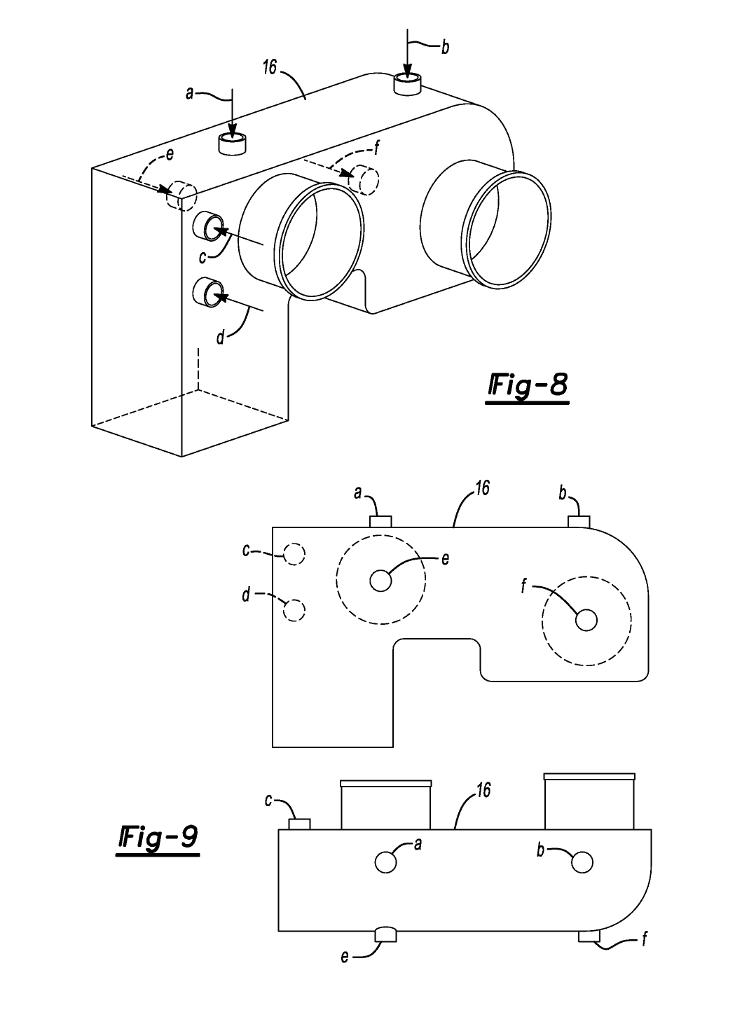

For the full system analysis, a mass flow rate of 3000 Kg/hr and an inlet temperature of 150° C. are applied at the manifold box inlet. At the burner inlet, a total mass flow of 1286 Kg/hr with temperature of 650° C. is applied. Since the current model is symmetric, half the flow rate of 1500 Kg/hr is applied at the turbo outlet. For the cases with 2 or 4 burners, mass flow of each burner is calculated based on the total required burner flow rate divided by the number of burners. In the initial design of experiments, 6 burner options are considered. The initial locations selected are presented in FIGS. 8 and 9. Design 1, identified as Top 4 Inlets, includes 4 burners having inlet locations at a and b. Design 2, identified as Back 4 Inlets, includes 4 burners having inlet locations at c and d. Design 3, identified as Front 4 Inlets, includes 4 burners having inlet locations at e and f. Design 4, identified as Top 2 Inlets, includes 2 burners having inlet locations at a. Design 5, identified as Back 2 Top Inlets, includes 2 burners having inlet locations at c. Design 6, identified as Back 2 Bottom Inlets, includes 2 burners having inlet locations at d. Design 7, identified as Design 6 offset 1, includes 2 burners having inlet locations at a mid-point between positions c and d. Design 7, identified as Design 6 offset 2, includes 2 burners having inlet locations one quarter the distance up from d toward c. In Design 4, Top 2 burner inlets on the inner legs are selected rather than outer legs because it is assumed that the impinging flow from turbo will partially divert the flow to outer legs as well. Front 2 inlet designs are not considered as the burner flow will be directed only to opposite leg and the outer bound legs may not receive significant burner mass flow like Top 2 inlet designs. Based on the positive results from Design 6, two additional designs, Design 7 and 8, are added in the follow-up study.

The rationale for burner location selection is based on packaging space and performance factors. Given the turbo flow impingement effect, ideas of Top-2 and Top-4 are conceived by mounting burner directly opposite to turbo-out flow direction, resembling the concept of mounting PCV valve nearby the strongest turbulence in intake manifold in gasoline engine applications. More design options are created to mount burners in the back and front of the turbo-out manifold.

The pressure drop, flow split and flow distribution are calculated for all 8 cases and presented in the following section. All the burner inlet designs are meshed in a different volume, so based on the design iterations each individual volume can be activated or deactivated. Due to the system symmetry, only two inlets are modeled for a system with 4 burners. Similarly, for the cases with 2 burners, only one is modeled in the half-model.

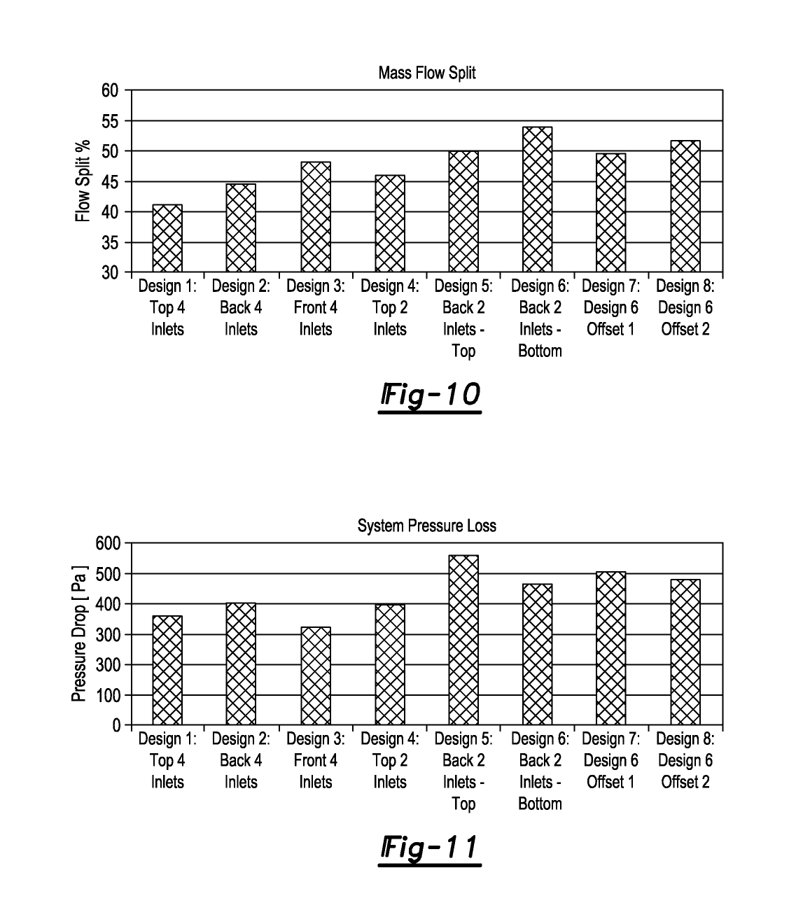

The total mass flow split and the system pressure loss from are presented in FIG. 10 and FIG. 11. The total mass flow is calculated from the sum of burner mass flow rate and exhaust mass flow rate. The system pressure loss is defined by the static pressure loss of the inlet as the outlet static pressure is treated as ambient boundary condition. Ideally, an evenly distributed flow will result in a flow split of 50% per leg. Since two legs share 100% of flow, only the percentage of leg 1, the one closer to the symmetry plane, is plotted. Because the average temperature and mass flow differs between legs, the pressure loss for individual legs also differs. Only the total pressure loss of the system is investigated in this section rather than individual legs. Ideally, if the manifold is design properly, the mass flow should be evenly split between downstream legs. In particular, if the manifold has large volume that possesses the capability to maintain a stable pressure, the downstream legs should have even share of exhaust gas. Interestingly, the results from 8 design options indicate that the manifold alone is not sufficient and burner inlets play important role as well. The results show that for four-inlet designs, mass flow rate of leg 1 is lower than that of leg 2. Whereas for the two-inlet design, the flow rate differs among three cases. This uneven distribution shows that the burner inlet locations and added heat play a vital role in the total mass flow (including both exhaust gas and burner heated gas) distribution to the legs. In addition, it was found that the pressure losses for four-inlet designs are lower than two-inlet designs. Design 5 and Design 7 indicate approximately 50% of flow percentage in leg 1, both designs achieved desire design target in mass flow rate split.

It is evident that burners play important roles in affecting exhaust mass flow split; typically the duration will last 30 minutes for active regeneration. It is also worth mentioning that during passive soot collection period (without burner heat) the full exhaust system has demonstrated even flow split among multiple legs or aftertreatment assemblies 30. It is understandably so as long as a stable pressure difference is maintained between manifold and exhaust stack-out.

It should be noted that the mass flow rate percentage of only aftertreatment assembly 30 is used in this paper because two aftertreatment assemblies 30 are modeled. If more parallel paths are present in a different system, standard deviations of mass flow rate across all aftertreatment assemblies are recommended, as defined in performance metric 1.

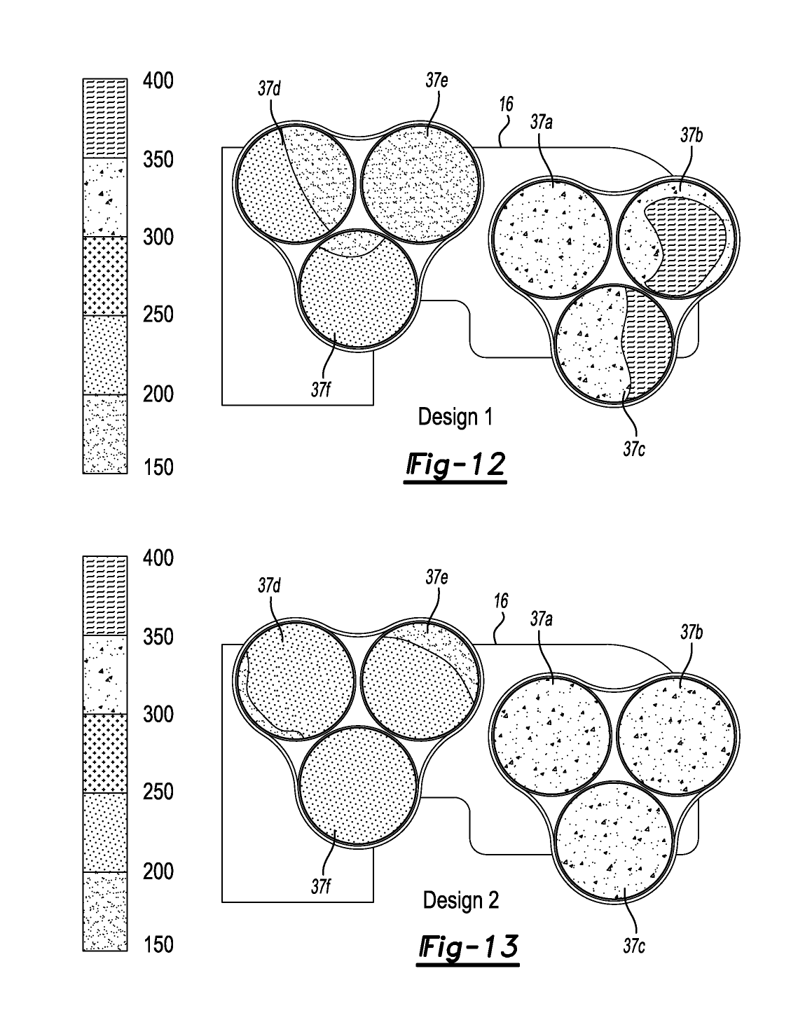

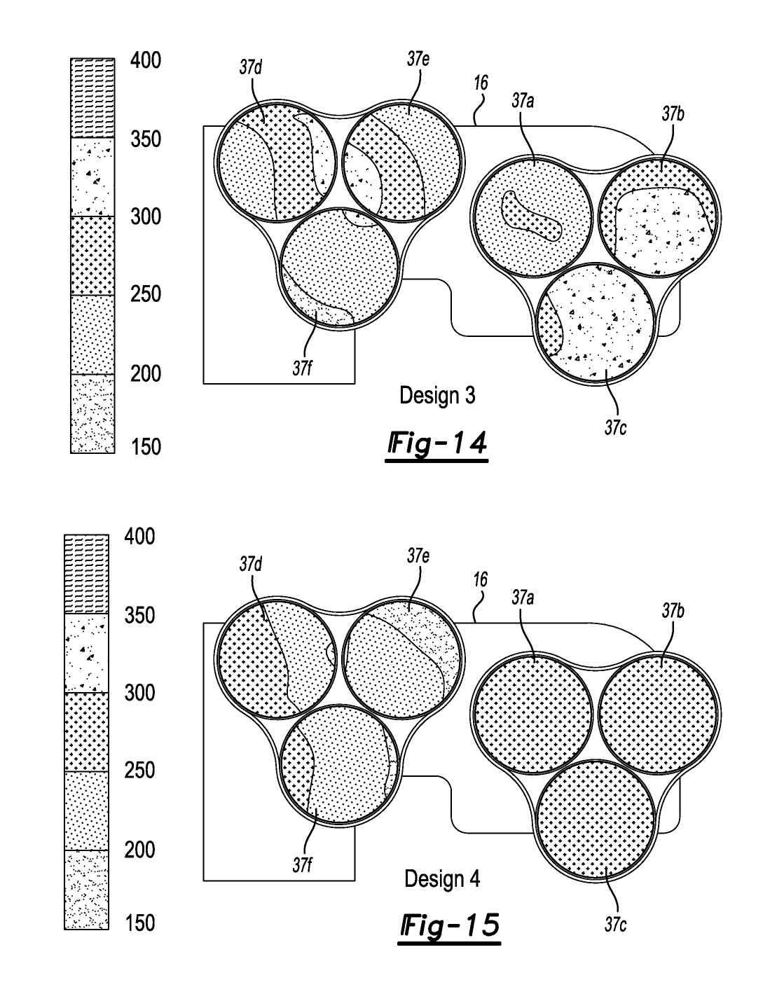

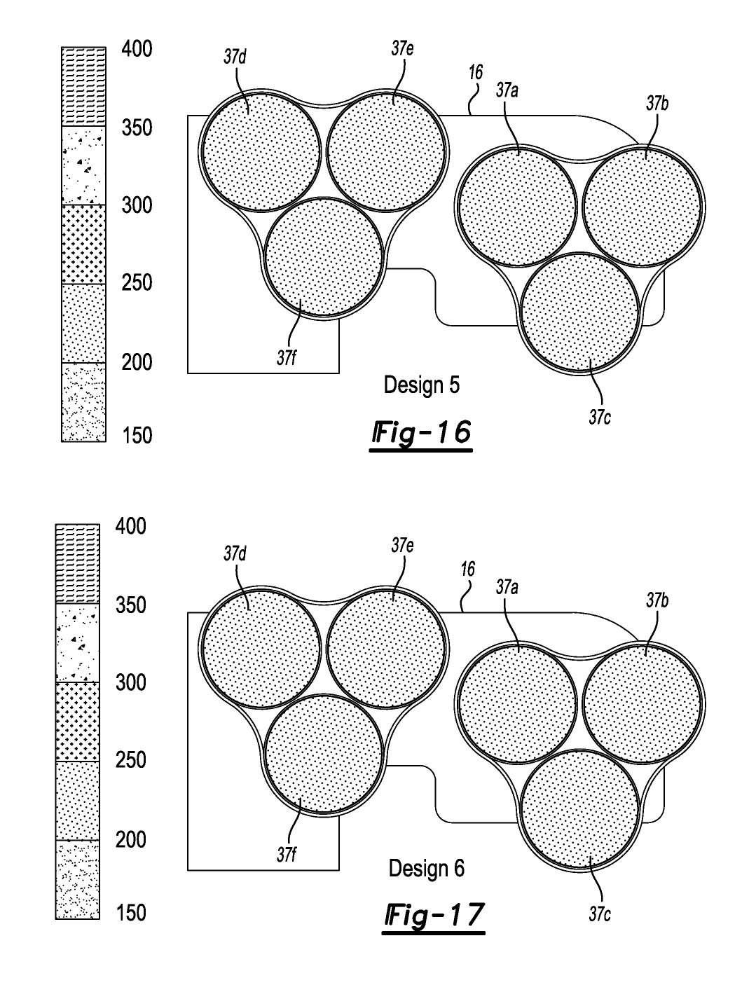

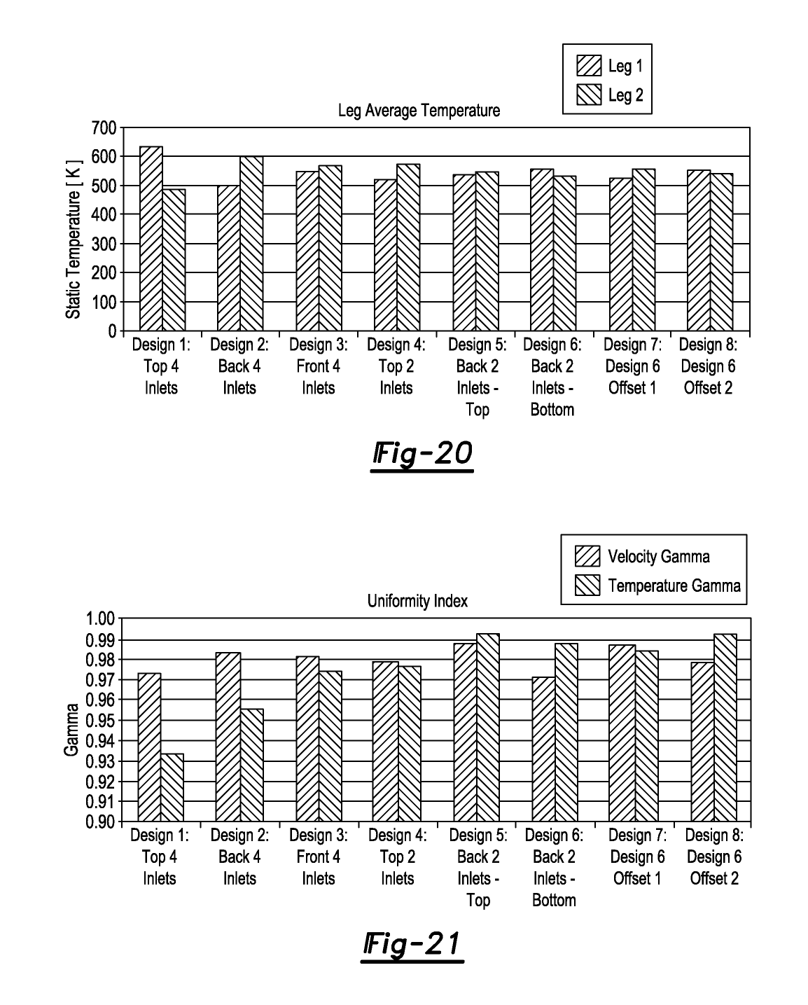

The main objective of introducing burners into the system is to raise the exhaust gas temperature for DOC lightoff especially at idle or low notch conditions. These burner inlets are placed at various locations in order to achieve a uniform temperature not only across each DOC face but also across legs. The static temperature distribution across DOC front faces for all the designs are presented in FIGS. 12-19. The average temperature of individual leg inlets are shown in FIG. 20.

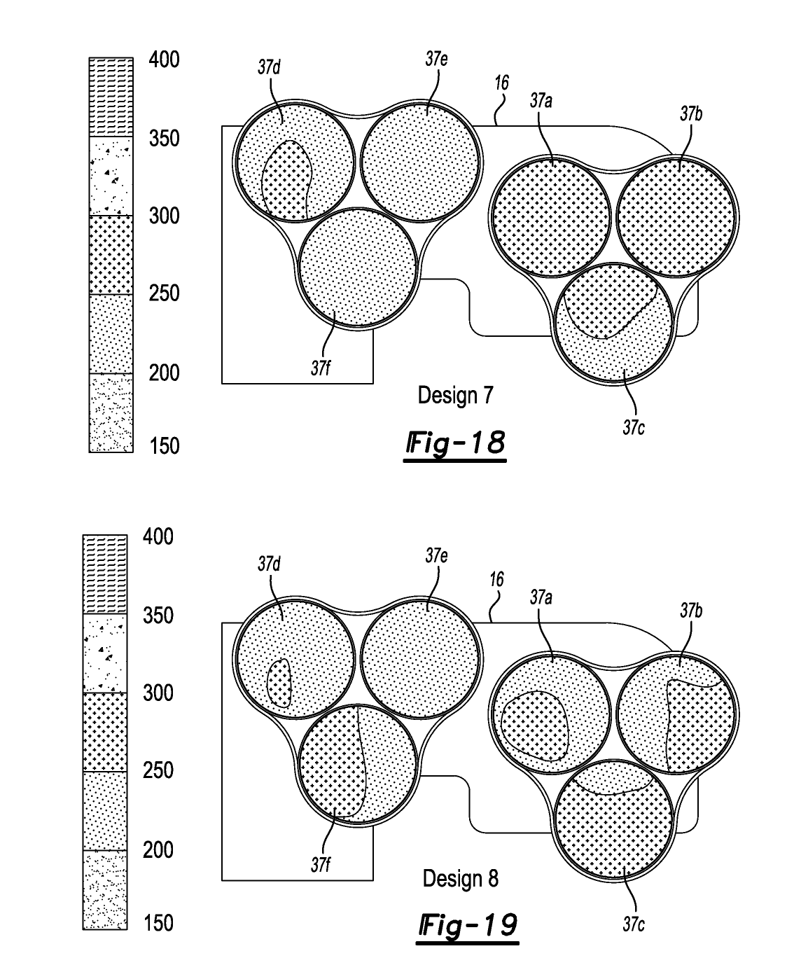

From design 1 results, the majority of the flow from the manifold inlet is directed towards leg 1 and hence leg 1 is subject to much higher thermal impact than leg 2. Design 2 results show similar flow patterns that lead to higher temperature at leg 2. From design 3, the burner flow facing the DOC inlet has better distribution compared to previous two designs. In design 4, one inlet at the top resulted in similar trend of first two designs, that is, the outer leg experiences higher temperature. From design 5 and 6, one burner at the top back or bottom back result in good distribution across both legs. Design 5 has slightly higher temperature at leg 1 whereas design 6 has slightly higher temperature at leg 2. It is therefore deduced that an inlet location in between these two designs would result in improved distribution. Comparisons of these design options indicate that design 3, as an intuitive option of facing burners directly to inlet of legs, fails to deliver the expected results. This phenomenon stresses the dominance of turbulence and swirl effect over laminar flow patterns. Based on the existing results from the flow split calculation and the temperature distribution, two more additional designs were created by offsetting the back inlets. The results of Design 7 and Design 8 are shown in FIGS. 18 and 19. Comparatively, design 8 shows better temperature distribution across the legs. Peak temperatures among both legs are comparable. In addition to velocity distribution, the performance is quantified through the velocity and temperature uniformity index.

The velocity uniformity is defined as,

$$U {I}_{\dot{m}} = 1.0 - 0.5 {\sum }_{i = 1}^{n} \frac{\vert {\dot{m}}_{i} \vert {A}_{i} - \dot{m} \vert A \vert}{\dot{m}} \cdot {A}_{i}$$

(6) and the temperature/enthalpy uniformity are defined by

$$U {I}_{Q} = 1.0 - 0.5 {\sum }_{i = 1}^{n} \frac{\vert {Q}_{i} \vert {A}_{i} - Q \vert A \vert}{Q} \cdot {A}_{i}$$

(7), where \dot{m} is the mass flow rate and Q is enthalpy flux.

FIG. 21 shows the velocity and temperature uniformity for all designs. It was observed that the temperature distribution of Design 5 with back 2 inlet designs achieves the best performance in temperature uniformity. It is worth noting that the temperature difference is not significant compared to the average face temperature, the uniformity numbers are therefore quite high for all designs. An alternative temperature index could be used to give better indication of temperature gradient than uniformity index.

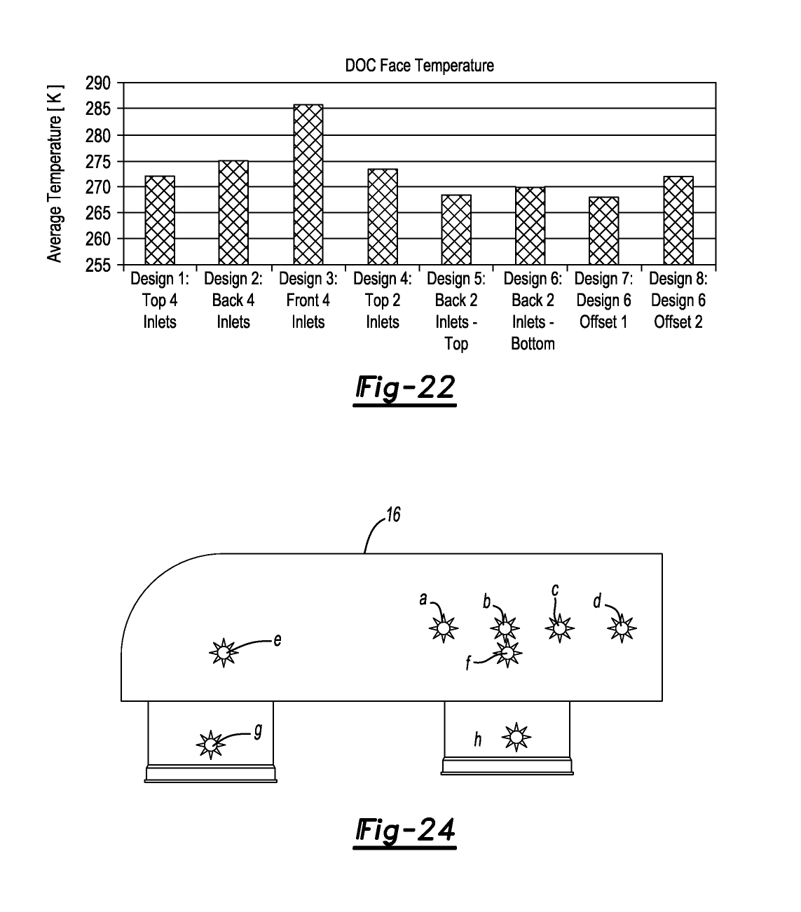

FIG. 22 shows the DOC inlet peak temperature for all the design options. Even though Design 3 yields high peak temperature, it is not uniformly distributed across the DOC. For overall system, velocity and temperature uniformities for the design 8 are shown in Table 2 and 3 respectively.

TABLE 2
Velocity gamma
Design 8: Design 6 offset 2

| DOC inlet | Axial Velocity | Gamma |
|---|---|---|
| System | 2.10 | 0.98 |
| Leg 1 | 2.19 | 0.98 |
| Leg 2 | 2.01 | 0.98 |
| Leg 1 - DOC 1 | 1.98 | 0.99 |
| Leg 1 - DOC 2 | 2.03 | 0.99 |
| Leg 1 - DOC 3 | 1.99 | 0.99 |
| Leg 2 - DOC 1 | 2.18 | 0.99 |
| Leg 2 - DOC 2 | 2.18 | 0.99 |
| Leg 2 - DOC 3 | 2.19 | 0.99 |

TABLE 3
Temperature gamma
Design 8: Design 6 offset 2

| DOC inlet | Average Temperature | Gamma |
|---|---|---|
| System | 544.93 | 0.99 |
| Leg 1 | 550.88 | 0.99 |
| Leg 2 | 538.58 | 0.99 |
| Leg 1 - DOC 1 | 546.99 | 1.00 |
| Leg 1 - DOC 2 | 534.94 | 0.99 |
| Leg 1 - DOC 3 | 536.05 | 0.99 |
| Leg 2 - DOC 1 | 547.81 | 0.99 |
| Leg 2 - DOC 2 | 550.65 | 0.99 |
| Leg 2 - DOC 3 | 555.19 | 0.99 |

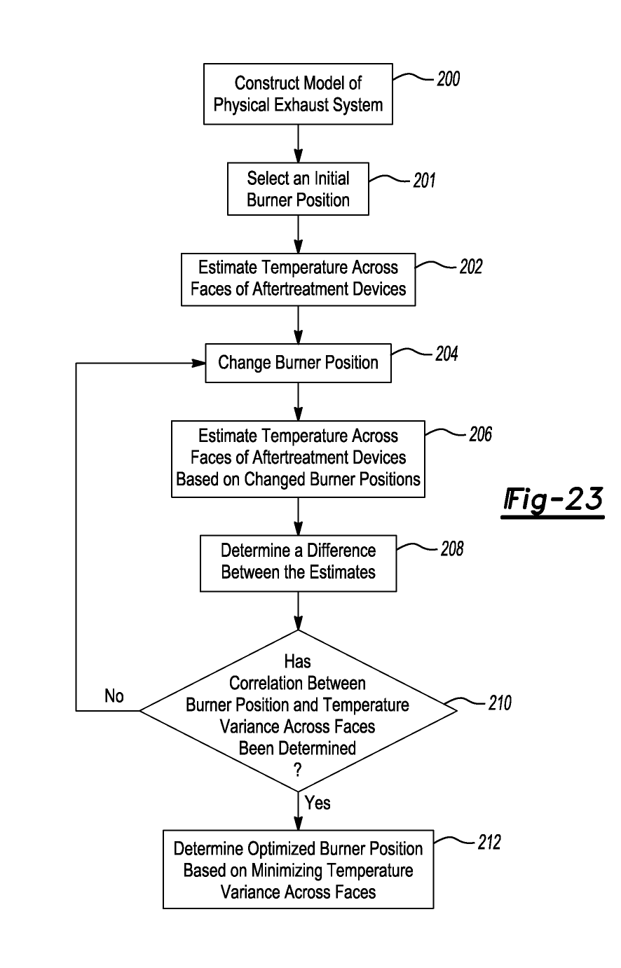

FIG. 23 provides a flow chart depicting a method of determining an optimized position for a burner in an exhaust aftertreatment system having multiple parallel exhaust gas flow paths as previously described. At step 200, a computer model is constructed based on the physical characteristics of the exhaust system to be modeled. Details regarding the size and shape of the exhaust manifold, the size and thermal output of the burner, and the exhaust flow rate of the engine are taken into account. At step 201, an initial position of the burner or burners is selected. At step 202, the temperature distribution across the faces of diesel oxidation catalysts 37a, 37b and 37c as well as 37d, 37e and 37f are estimated using a computer process performing computational fluid dynamic modeling. At step 204, the model is modified by changing the burner position. At step 206, another estimate of the temperature across the faces of the aftertreatment devices is made based on the changed burner position. At step 208, a difference between the estimates is determined. At step 210, it is decided whether a correlation between the burner position and temperature variance across the diesel oxidation catalyst faces has been determined. If not, additional different burner positions are modeled and estimates of temperature across the faces of the aftertreatment devices are made based on the different burner positions until the correlation between burner position and temperature variance is determined. At step 212, an optimized burner position is determined based on minimizing the temperature variance across the faces of the diesel oxidation catalyst. Other method steps, including estimating an exhaust gas mass flow across each parallel exhaust path based on the initial burner position and the changed position may also be made. The optimized burner position may be based on both the temperature variance as well as minimizing a difference in the exhaust gas mass flow across the parallel paths.

A similar CFD geometry is used for a sensitivity study of injector locations. The injector location optimization is similar to burner studies in that the locations of injector affect the diesel mixing performance. Based on the available packaging space, the injector locations are selected and spray modeling is conducted to predict the droplet trajectories in discrete phases. Via evaporation of droplets, the resulting species distribution across the DOC faces helps identify the optimized location for the specific manifold design.

The run condition is selected such that mass flow rate is 18000 Kg/hr with inlet temperature of 320° C. Steady state particle tracking in discrete phase model is applied. Hydrocarbon property of C₁₀H₂₂ with a total mass flow rate of 177 Kg/hr is applied with droplets being released into the exhaust stream via discrete parcels. Rosin Rammler diameter distribution for the spray modeling is determined from the PDPA tests of the injector. The measured spray angle of 67 degree and injector velocity of 20 m/sec are applied as the initial properties. The tentative injector locations are shown in FIG. 24 where multiple injector locations and numbers are studied, resulting in four options. The number of injectors is for the symmetry model and hence for the full system design, the injectors have to be mirrored. In this symmetry model, Option 1 is composed of 2 injectors at positions c and d (for full model it will be 4 injectors) placed right above the manifold inlet. Option 2 includes 2 injectors placed in the manifold just upstream of the inlet of each leg at positions e and f. Option 3 design is composed of 2 injectors, placed on the inlet pipe of each leg at locations g and h. Option 4 location is composed of 4 injectors, placed in series above the manifold inlets at positions a, b, c and d.

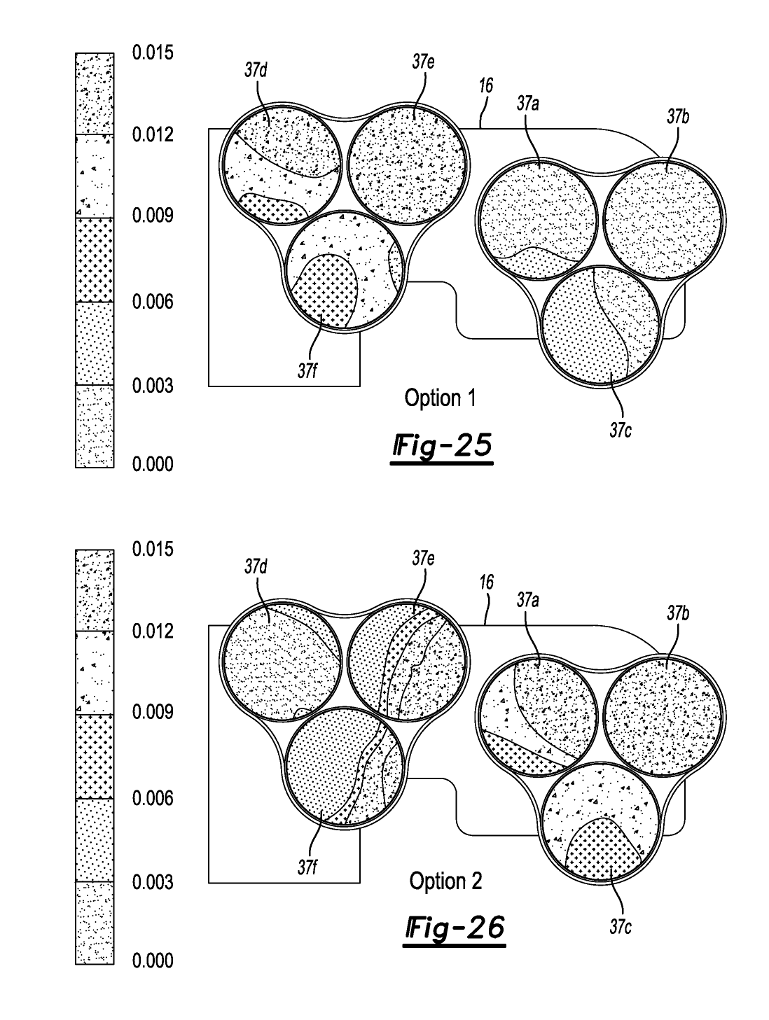

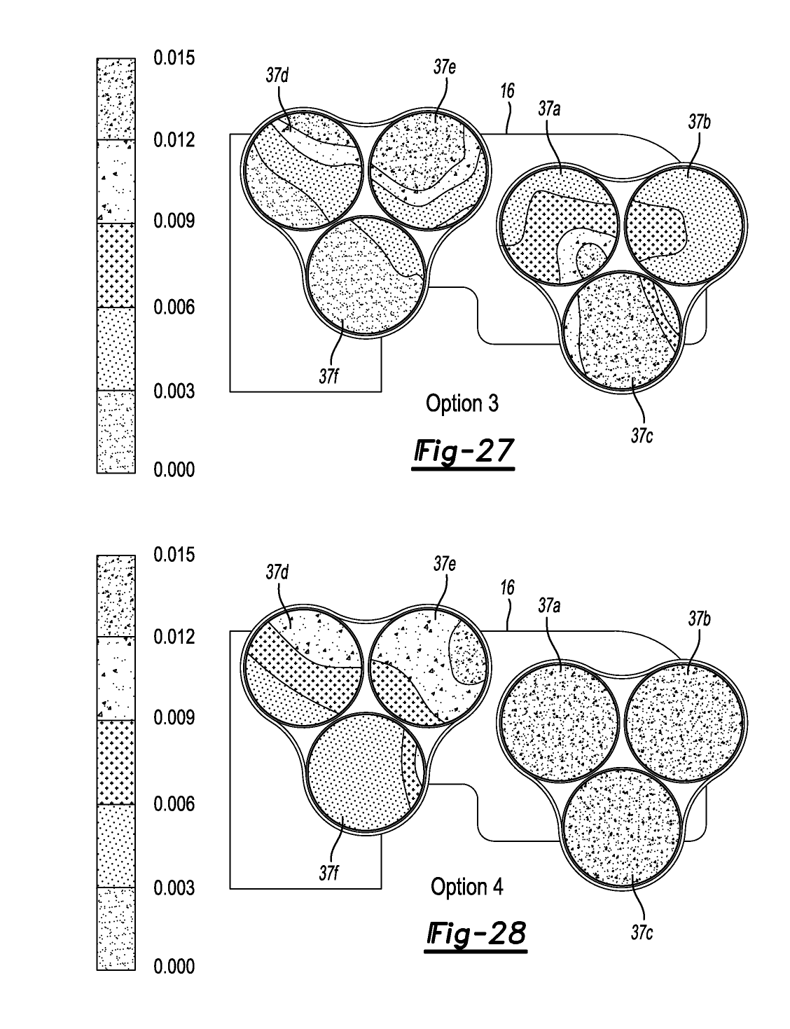

The mass fraction of hydrocarbon (HC) vapor evaporated from the droplets is the main factor of interest. The uniform distribution of species across the substrate faces is expected to indicate the mixing performance (Explicit in Metric 4). Contours of vapor concentrations are shown in FIGS. 25 to 26. Vapor mass flow rate per leg is another important factor, which can be calculated from vapor distribution at DOC faces (implicit in Metric 4).

Option 1 result shows that most of the droplets tend to get into leg 2 due to turbulence effect, leading to a low dosing rate for DOC at leg 1. In Option 2, even though the injector is mounted on the inlet of leg 2, the incoming flow takes away the particles after impinging on the top wall and carries them to the leg 1. In both cases, the distributions across legs are significantly different but the species distribution at a specific DOC may be uniform, indicating that uniformity indices should be used across all six DOCs. To address the misdistribution of HC, a tentative idea was proposed that each injector flow rate may vary to mitigate flow induced misdistribution patterns. However, this idea may not be feasible because of added complexity and unnecessary burden in injector controls. Generally, hardware optimization is the preferred way to optimize system performance; varying dosing rate alone should only be used as the last resort.

From vapor contours in Option 3, it was observed that the individual injector for each leg reaches desired dosing rate, but vapor distributions are poor for individual DOC due to short mixing length. For leg 2, the top DOC receives higher concentration than the bottom one; for leg 3, the trend is opposite. Such difference in distribution is a direct result of interaction between turbulent flow patterns and HC droplet transport trajectory prior to reaching the DOC faces. To better understand the design implications, the pros and cons of two mounting options are described in Table 4.

TABLE 4
Pros and Cons of injector mount locations on legs vs. on turbo-out box

| | | Diesel mixing |
|---|---|---|
| Mounting Options | Dosing rate control per leg | performance |
| Mount the injectors | Difficult because of vapor | Good because of long |
| on turbo box | transport in turbo box is | mixing length |
| | hard to manage | |
| Mount the injectors | Easy because of dosing is | Poor because of short |
| on each leg | limited in each leg | mixing length |

Understanding of tradeoffs allows one to select a location that enables droplets to mix well with the flow before they enters the leg. One way is to mount the injectors directly on top of the turbo outlet pipe upstream of the manifold.

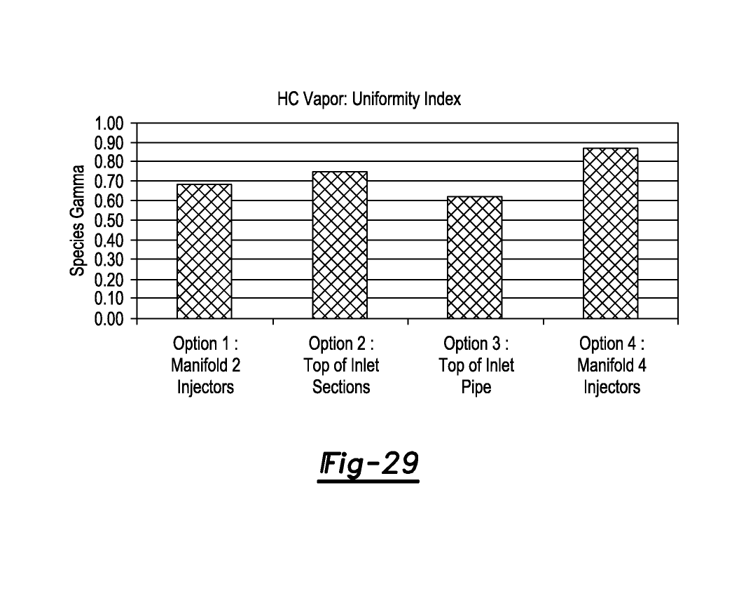

As evident in Option 1, the resulting diesel mass flow rates may vary across legs. One way to circumvent this limitation is to use more injectors to allow better dosing allocations. In Option 4, four injectors are mounted on top of turbo-out box. The species distribution for this design is shown in FIG. 28. It was observed that the species gradient for this case is significantly lower compared to the other design options.

Similar to temperature uniformity, the species or vapor uniformity can be calculated for these design options to quantify the performance of injector location optimizations. The results are presented in FIG. 29. Option 4 results in significant improvements in vapor distribution with uniformity index close to 0.9; therefore it is the best design among four options. Admittedly, Option 4 could be further improved by raising the uniformity index to 0.95; however it is deemed unnecessary as the purpose is to provide illustrative examples on system development methodologies. If needed, the system performance can be improved further with additional design modifications of injector locations, deflectors and baffles to enhance mixing.

A method of determining an optimized position for a reagent injector in an exhaust aftertreatment system having multiple parallel exhaust gas flow paths is accomplished in a substantially similar manner to that previously described in relation to optimizing the position for the burner as depicted at FIG. 23. Various injector positions may be modeled such that the reagent injection distribution across the faces of several parallel positioned exhaust aftertreatment systems may be estimated. A difference between the estimates for the different injector positions may be determined and an optimized injector position may be determined based on minimizing the variance of the reagent distribution. A species uniformity or reagent uniformity index may also be used to provide a method of numerically determining the particular injector position exhibiting the minimum variance across the faces of the diesel oxidation catalyst.

This disclosure provides general design principles and methodologies for a representative manifold geometry with the objective to achieve multifaceted design targets for diesel turbo-out manifold. Such principles and methodologies can be applied to optimize similar large diesel turbo manifold geometry.

Overall aftertreatment system layout, the design rules, and performance metrics are provided to evaluate a turbo manifold subsystem. Given the tradeoffs between tests and simulations, CFD thermal and spray modeling are adopted as the main tool due to its cost-effectiveness and rapid development cycle. It is employed to optimize burner mounting locations and injector mounting locations. Equipped with such tools, a representative manifold is provided to explain the concept of design optimization. The specific manifold design was to evenly distribute burner heat, diesel vapor and exhaust gas through catalytic subsystems which are composed of multiple identical legs with complete functionality to reduce HC, CO, PM and NOx. Given this specific manifold, design optimizations on burner and injector locations have been performed.

Successes have been achieved from burner and HC layout optimizations. In the burner layout study, flow split per leg and temperature distribution are predicted for progressive designs, resulting in the optimized design of burner mounting locations. Among the 8 designs, Design 5 (2 burners on the back of the manifold) yields the best temperature distribution across the DOC face. In injector layout study, the fuel mass flow rate per leg and the mass fraction of evaporated HC species distribution are analyzed. Among 4 design options, Option 4 (4 injectors mounted on top of the manifold box) resulted in the best design in diesel vapor distribution and vapor mass flow rate per leg.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of determining an optimized position for a burner in an exhaust aftertreatment system having multiple parallel exhaust gas flow paths, the method comprising:
estimating, by a computer process, temperature distributions across faces of exhaust treatment devices positioned within the parallel paths based on an initial burner position upstream of the parallel paths;
changing the burner position;
estimating the temperature distribution across the faces of the exhaust treatment devices based on the changed burner position;
determining a difference between the estimates;
repeating the changing, estimating and determining steps to correlate the burner position with a temperature variance across the faces; and
determining an optimized burner position based on minimizing the temperature variance across the faces of the exhaust treatment devices.

2. The method of claim 1, further including estimating an exhaust gas mass flow across each parallel exhaust path based on the initial burner position and the changed position, the method including determining the optimized burner position based on the temperature variance and minimizing a difference in the exhaust gas mass flow across the parallel paths.

3. The method of claim 2, further including estimate a pressure loss in the aftertreatment system based on the initial and changed burner positions and determining the optimized burner position based on minimizing the pressure loss.

4. The method of claim 1, further including estimating an injected species distribution based on an initial injector position and a different injector position, the method including determining an optimized injector position based on a comparison of the species distribution estimates.

5. The method of claim 1, wherein the aftertreatment system includes an exhaust manifold having multiple outlets providing exhaust to the parallel paths, the method including determining a burner mounting location on the exhaust manifold.

6. The method of claim 5, wherein estimating the temperature distributions across faces of exhaust treatment devices positioned in parallel includes modeling the exhaust flow through the exhaust manifold and a heated air flow through the burner using computational fluid dynamics.

7. The method of claim 6, wherein estimating further includes considering burner size, burner power output, a number of burners, and a burner exit gas temperature.

8. The method of claim 7, wherein estimating the temperature distributions includes considering the burner exit gas temperature at 650° C.

9. The method of claim 8, further including determining whether more than one burner is required.

10. The method of claim 9, wherein determining whether more than one burner is required includes modeling exhaust flow at an engine idle speed.

11. The method of claim 5, further including mounting the burner to the exhaust manifold at the optimized position.

12. The method of claim 9, wherein determining whether more than one burner is required includes setting a target temperature at the faces of the exhaust treatment devices to be a diesel oxidation catalyst activation temperature of 285° C.

13. A method of determining an optimized position for a reagent injector in an exhaust aftertreatment system having multiple parallel exhaust gas flow paths, the method comprising:
estimating, by a computer process, injected reagent distributions across faces of exhaust treatment devices positioned within the parallel paths based on an initial reagent injector position upstream of the parallel paths;
changing the reagent injector position;
estimating injected reagent distribution across the faces of the exhaust treatment devices based on the changed reagent injector position;
determining a difference between the estimates; and
determining an optimized reagent injector position based on minimizing the reagent distribution variance across the faces of the exhaust treatment devices.

14. The method of claim 13, further including determining an injected reagent uniformity across the faces of the exhaust treatment devices based on the initial reagent injector position and the changed position, the method including determining the optimized reagent injector position based on providing the greatest uniformity index.

15. The method of claim 14, wherein the aftertreatment system includes an exhaust manifold having multiple outlets providing exhaust to the parallel paths, the method including determining a reagent injector mounting location on the exhaust manifold.

16. The method of claim 15, wherein estimating the injected reagent distributions across faces of the exhaust treatment devices includes modeling a mixing of the exhaust flow and the injected reagent within the exhaust manifold using computational fluid dynamics.

17. The method of claim 16, wherein the estimating further includes considering an injected reagent spray angle and an injected reagent velocity.

18. The method of claim 15, further including mounting the reagent injector on the exhaust manifold at the determined location.

19. A method of determining an optimized position for an emissions control device in an exhaust aftertreatment system having multiple parallel exhaust gas flow paths, the method comprising:
estimating, by a computer process, temperature distributions across faces of exhaust treatment devices positioned within the parallel paths based on an initial emissions control device position upstream of the parallel paths;
changing the emissions control device position;
estimating the temperature distribution across the faces of the exhaust treatment devices based on the changed emissions control device position;
determining a difference between the estimates;
repeating the changing, estimating and determining steps to correlate the emissions control device position with a temperature variance across the faces; and
determining an optimized emissions control device position based on minimizing the temperature variance across the faces of the exhaust treatment devices.

20. The method of claim 19, further including estimating an exhaust gas mass flow across each parallel exhaust path based on the initial emissions control device position and the changed position, the method including determining the optimized emissions control device position based on the temperature variance and minimizing a difference in the exhaust gas mass flow across the parallel paths.

21. The method of claim 20, further including estimate a pressure loss in the aftertreatment system based on the initial and changed emissions control device positions and determining the optimized emissions control device position based on minimizing the pressure loss.

22. The method of claim 19, wherein the aftertreatment system includes an exhaust manifold having multiple outlets providing exhaust to the parallel paths, the method including determining an optimal emissions control device mounting location on the exhaust manifold.

23. The method of claim 22, wherein estimating the temperature distributions across faces of exhaust treatment devices positioned in parallel includes modeling the exhaust flow through the exhaust manifold and a heated air flow through the emissions control device using computational fluid dynamics.

24. The method of claim 23, wherein estimating further includes considering emissions control device size, emissions control device power output, and a number of emissions control devices.

25. The method of claim 24, wherein estimating the temperature distributions includes considering the emissions control device exit gas temperature at 650° C.

26. The method of claim 25, further including determining whether more than one emissions control device is required.

27. The method of claim 26, wherein determining whether more than one emissions control device is required includes modeling exhaust flow at an engine idle speed.

28. The method of claim 22, further including mounting the emissions control device to the exhaust manifold at the optimized position.

29. The method of claim 26, wherein determining whether more than one emissions control device is required includes setting a target temperature at the faces of the exhaust treatment devices to be a diesel oxidation catalyst activation temperature of 285° C.

30. The method of claim 19, wherein the emissions control device includes a reductant injector.

31. The method of claim 19, wherein the emissions control device includes a burner.

32. The method of claim 19, wherein the emissions control device includes a flow modifier.
